(19) United States
(12) Patent Application Publication
(10) Pub. No.: US 2015/0193700 A1
(43) Pub. Date: Jul. 9, 2015

(54) CREATING A TICKET TEMPLATE FOR AN EVENT

(71) Applicant: Eventbrite, Inc., San Francisco, CA (US)

(72) Inventors: Jon Bastin, San Francisco, CA (US); Jason Bayly, San Francisco, CA (US); Sean Porter, Denver, CO (US); Kyle O'Brien Crumrine, Oakland, CA (US)

(21) Appl. No.: 14/476,590

(22) Filed: Sep. 3, 2014

Related U.S. Application Data
(60) Provisional application No. 61/924,135, filed on Jan. 6, 2014.

(51) Int. Cl. G06Q 10/02

(52) U.S. Cl. CPC G06Q 10/02

(57) ABSTRACT

A system and method for creating a ticket template for a specified venue. An online event management system includes tools for creating or editing a seating arrangement for the venue, and creating or editing a ticket map that corresponds to the seating arrangement. The ticket map is integrated with the seating arrangement to form a ticket template for the venue. The ticket template is published as a final seating plan for the event at the venue, and can be saved for use or modification with a future event at the venue.

### CROSS REFERENCE

This disclosure claims priority from U.S. Provisional Patent Application No. 61/924,135 entitled Creating a Ticket Template for an Event, filed Jan. 6, 2014, and incorporated by reference herein.

### TECHNICAL FIELD

This disclosure relates generally to online event management systems, and in particular, to the use of an online event management system to arrange a venue for an event, including the creation of a seating and ticketing plan for the event.

### BACKGROUND

Some websites allow users to organize events using an online event management system, such as the Eventbrite event management platform hosted by Eventbrite, Inc., of San Francisco, Calif. Thus, using such a system, an event organizer may organize and manage various aspects of an event, such as managing attendee registrations, selling tickets, promoting the event, and managing attendee check-in at the event. An online event management system may also allow customers to view event profiles, register for events, and purchase tickets for events.

Commercial providers of ticketing services, such as Ticketmaster® and StubHub®, have proprietary software tools for generating ticketing arrangements for established seating plans at a limited number of popular venues. However, it is generally not possible for anybody to create or customize site arrangements for an event at any venue, such as the user's backyard, a local park, the local veteran's hall, etc., including the seating arrangement and a corresponding ticket plan, although it would be desirable to do so.

### BRIEF DESCRIPTION OF THE DRAWINGS

FIG. 1 is a diagram illustrating a network environment for implementing an online event management system.

FIG. 2 is a flow chart illustrating a process for creating a ticket template for an event.

FIG. 3 is a flow chart illustrating a process for creating a seat map for use with a ticket template.

FIG. 4 is a flow chart illustrating additional details of the process of FIG. 3 for creating a seat map for use with a ticket template.

FIG. 5 is a flow chart illustrating a process for creating a ticket template from the seat map created in FIG. 4.

FIG. 6 is a flow chart illustrating a process for assigning tickets to the seat map created in FIG. 4.

FIG. 7A is a diagram illustrating a graphical user interface having a blank canvas to initiate creation of a seat map.

FIG. 7B is a diagram illustrating the placement of tables on the graphical user interface of FIG. 7.

FIG. 7C is a diagram illustrating a completed seat map having table placement on the graphical user interface of FIG. 7.

FIG. 8A is a diagram illustrating a pre-existing seat map uploaded as a background image on the graphical user interface of FIG. 7A.

FIG. 8B is a flow chart illustrating how to create a section.

FIG. 8C is a diagram illustrating the tracing of discrete sections from the background image shown in FIG. 8A.

FIG. 8D is a diagram illustrating how to fill sections created by tracing the background image as shown in FIG. 8C.

FIG. 9A is a diagram illustrating a “focus mode” in which attributes of individual tables and/or chairs may be entered or edited on the seat map.

FIG. 9B is a diagram illustrating a “focus mode” in which attributes of individual sections may be entered or edited on the seat map.

FIG. 10 is a block diagram illustrating one embodiment of a computing system implemented as an online event management system.

### DETAILED DESCRIPTION

1. System Overview

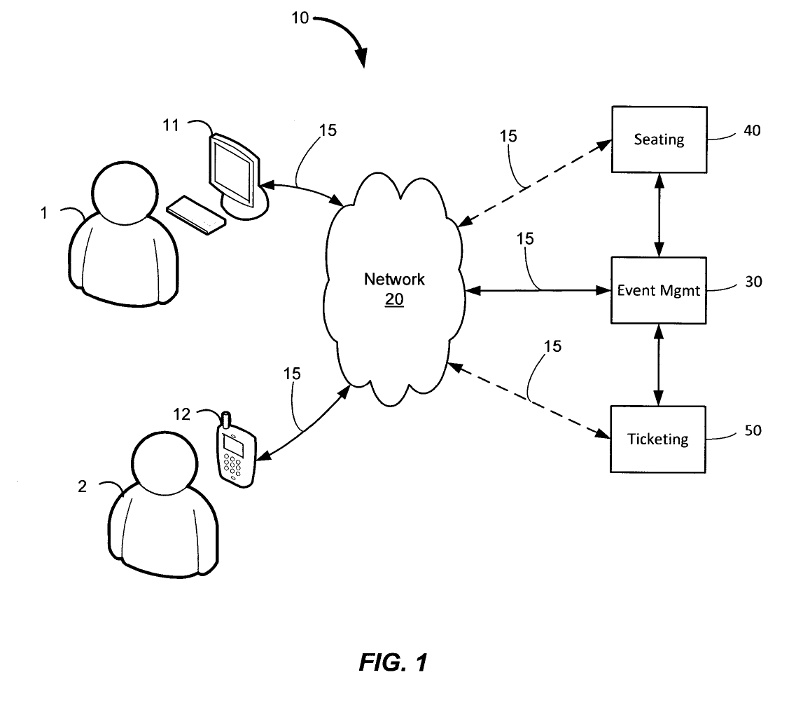

FIG. 1 illustrates one embodiment of a system 10 for implementing online event management. System 10 includes a first user 1 using a client system 11 and a second user 2 using a client system 12 to access an event management application 30 via network 20. For example, the first user 1 may use the event management application 30 in order to create and manage an event, including seating and ticketing for the event, while the second user 2 may use the event management system to register for and/or purchase tickets to attend the event. Although FIG. 1 illustrates a particular arrangement of users 1, 2, client systems 10, 11, network 20, and event-management application 30, this disclosure contemplates any suitable arrangement. As an example, two or more client systems may be directly connected to the event management application 30, bypassing network 20.

In one embodiment, the event-management application 30 is a network-addressable computing system hosting a web service that runs a software-based application for organizing and managing events. The event-management application 30 can include a seating module 40 for organizing seating and seating related objects for an event, which may be an integral part of the application, or it may stand alone as a separate related program module. Likewise, the event-management application 30 can include a ticketing module 50 for organizing ticketing for the event and associating specific tickets with specific seats or seating objects, which may be an integral part of the application, or it may stand alone as a separate related program module. The use of the terms “ticket” or “ticketing” are not intended to imply that a cost is associated with a ticket for an event, although that is of course one possibility. More generally, the terms are used to refer to a reservation or holding place associated with a specific seat or seating object.

The event-management application 30 may generate, store, receive, or transmit event-related data, for example, event listings, event information details, event history details, event registration details, event organizer details, event attendee details, ticket purchase details, attendee check-in details, event displays, etc. Users may access, send data to, and receive data from the event-management application 30 using client systems, such as client systems 11 and 12, which may be any suitable computing device, for example, a personal computer, a laptop, a cellular phone, a smartphone, a personal digital assistant, an ultra-mobile PC, or a computing tablet.

Network 20 may be any suitable communications network. For example, one or more portions of network 20 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, another suitable network, or a combination of any of these.

The client systems 11, 12 and event-management application 30 are connected to network 20 (or to each other in alternative embodiments) by connections 15. The connections 15 may include one or more wireline connections, such as Digital Subscriber Line (DSL) or Data Over Cable Service Interface Specification (DOCSIS); wireless connections, such as Wi-Fi or Worldwide Interoperability for Microwave Access (WiMAX); or optical connections, such as Synchronous Optical Network (SONET) or Synchronous Digital Hierarchy (SDH). One or more connections 15 may include an ad hoc network, an intranet, an extranet, a VPN, a LAN, a WLAN, a WAN, a WWAN, a MAN, a portion of the Internet, a portion of the PSTN, a cellular telephone network, another suitable connection, or a combination of any such connections.

2. Event Management

A web-based software application for event-management allows a user to create, organize and manage an event at a specific venue. The event may be a party, a concert, a conference, a sporting event, a fundraiser, a networking event, or a live performance, for example. Events may occur online (such as a web-based seminar) and offline (such as a live seminar in a lecture hall). A venue may be a stadium, a hall, an auditorium, a hotel, a camp site, a beach, a standing area, a general admission area, or any suitable outdoor and indoor locations, for example.

The user may create an event profile for the event and input event information associated with the event. The event profile may be viewable in one or more webpages or other content served by the event-management system. A second user, such as an event attendee, may then use the event-management system to register for the event. As used herein, the terms “user” and “event attendee” may be used interchangeably to refer to a user who registers for and attends an event. The second user may view an event profile associated with the event and then register or purchase tickets for the event.

Although this disclosure uses the term “ticket,” this disclosure is applicable to events that do not use physical tickets and even ticketless events where attendees merely register for the event. Thus, unless the context suggests otherwise, the term “ticket” (whether alone or when used in conjunction with other terms) may be considered synonymous with “registration.”

The event management system may have an event profile associated with each event managed by the system. An event profile may be accessed and displayed by any suitable client system. An event profile may include event information describing the event title, the event date/time, the event category or type, the event details, the description of the event, the event cost or ticket price for the event, the event organizer, the event promoter, the geographic location of the event, the venue for the event, a seat map for the event, a venue capacity, the performer for the event, the number of tickets available for the event, the type/class of tickets available for the event, the ticket identifiers, the number of reserved seats available for the event, the location/type/class of reserved seats available for the event, the selling prices of the reserved seats for the event, the selling order of the reserved seats for the event, the event attendees, the attendee check-in status of each event attendee, the ticket-selling window (a start time and an end time during which tickets can be sold), purchase information for the event, an attendee list for the event, references to additional information (such as, for example, hypertext links to resources related to or describing the event, historical sales data for the seats of the events, and the like), privacy settings for the event profile, or other suitable event information.

The event profile may also include a total number and type of tickets that are available for the event. The type of tickets available for an event may include, for example, premium tickets, general admission tickets, reserved seat tickets, another suitable type of tickets, or two or more such types of tickets. There may be various numbers of each ticket type available for the event. The number of tickets available for an event may be based on a variety of factors. As an example, the event organizer or venue owner may specify a particular number of tickets that may be sold for the event. As another example, the number of tickets that may be sold may be based on the size or capacity of the venue.

The event profile may include reserved seat information for the event. The reserved seat information may include, for example, seating arrangements for the event at the specified venue, the total number of reserved seats for sale by the event organizer for each seating arrangement, the location or position of each reserved seat with reference to each seating arrangement, the location or position of each door with reference to each seating arrangement, the location or position of each wheelchair seat with reference to each seating arrangement, the type or class of each reserved seats, an estimated selling price for each reserved seat, a selling order for each reserved seat, or other suitable reserved seats information.

The event management system 170 may comprise one or more related services that allow a user to organize events. As an example, the event management system may present the user with software tools to develop an online or mobile website for each event. The website may be configured to allow customers to register for the event and purchase tickets.

The event management system may offer software tools to enable a user to promote the event. For example, the software tools may present options for providing event information via email, text or messaging, including sending personalized invitations to pre-determined contacts, listing non-private events on search engine or in public directories, or promoting events to friends via social networks such as Facebook, Twitter, or Linkedin. The event management system may enable the event organizer to track attendance, including but not limited to, emailing attendees and sending event reminders regarding tickets, seating and/or other event information, managing group registration, sending professional invitations, viewing ticket sales and/or registration information, determining the number of attendees, estimating the total revenue from sales of the reserved seats, tracking the sale of each reserved seat, accessing sales data at any time, scanning tickets, and managing discounts, group and members-only registration.

3. Creating a Seating Arrangement

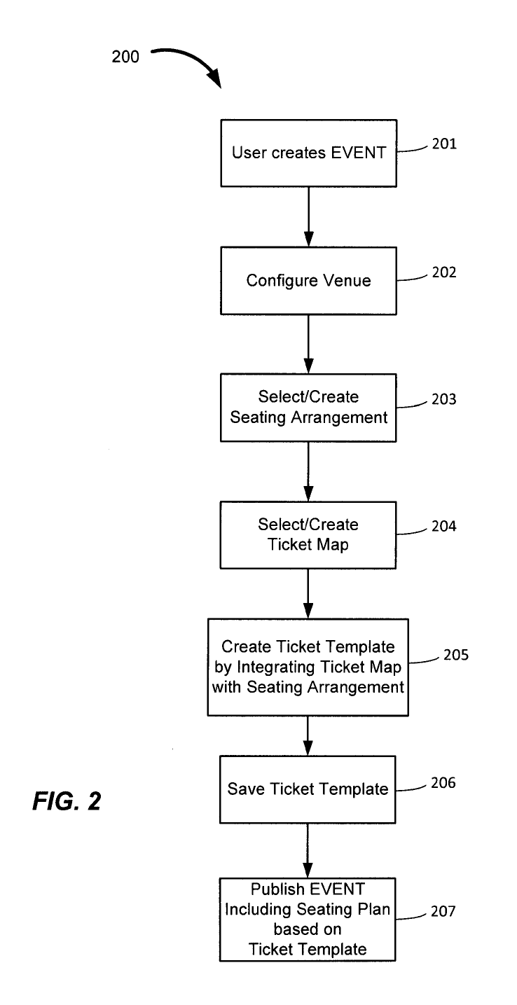

FIGS. 2-6 illustrate a series of processes for creating a ticket template for a venue using event management software hosted on a network web site. The term “ticket template” is intended to refer to a combination of a specific seating arrangement and a specific ticket map for a particular venue, including layout of sections, tables and chairs, for example, and any overlay for ticket, pricing, reservations, or other key attributes. The ticket template is ultimately used to generate a specific seating plan for an event at the particular venue, and the seating plan will be published with the event. The ticket template may be re-used for other events at the same venue, or may be modified to create a different seating arrangement and/or ticket map for the venue for other events.

Referring to FIG. 2, in step 201, a user initiates creation of a new EVENT, including relevant details such as event name, date, hours, location (venue), etc. Although many details are involved in organizing and planning an event, process 200 is only concerned with specifying the seating and ticketing details for a particular event at a specific venue. Therefore, in step 202, a process for configuring the venue for the event is selected from a menu that is organized to direct the user to actions that will manage the event.

Configuring the venue for an event generally involves three steps: selecting or creating a seating arrangement for the specific venue (step 203); selecting or creating a ticket map for the seating arrangement (step 204); and integrating the ticket map with the seating arrangement to form a ticket template as a seating plan for the event at that venue (step 205). These steps may be performed as part of an integrated process 300, described below, or handled separately. In step 203, the seating arrangement may be created from scratch, or selected from a list of pre-existing seating arrangements, or created by modifying a pre-existing seating arrangement, as further described below. Likewise, in step 204, a ticket map for a particular seating arrangement may be created from scratch, or selected from a list of pre-existing ticket maps, or created by modifying a pre-existing ticket map, as further described below. In step 205, a ticket template for a venue is created by combining a specific seating arrangement with a specific ticket map. Since there could be different seating arrangements and/or different ticket maps for a particular venue, there could be multiple ticket templates for a particular venue.

In step 206, the ticket template, which is generated from combination of the seating arrangement and the ticket map, is saved in a data store. In step 207, the event is published with a seating plan based on the ticket template. More specifically, the ticket template is retrieved from storage and made into the active seating plan for the current event. Thus, when the event is published, all sales, reservations, inquiries, selling order, etc., of ticketed seats are controlled through event management software utilizing the seating plan.

Because the ticket template is stored, it may be retrieved and reused “as is” for this venue, or it may be modified to form a different ticket template for the venue. For example, a user may retrieve a stored ticket template, modify the seating arrangement, in which case a new ticket map must also be configured, then generate and save the new ticket template. As another example, a user may retrieve a stored ticket template, modify the ticket map for the existing seating arrangement, then generate and save another new ticket template.

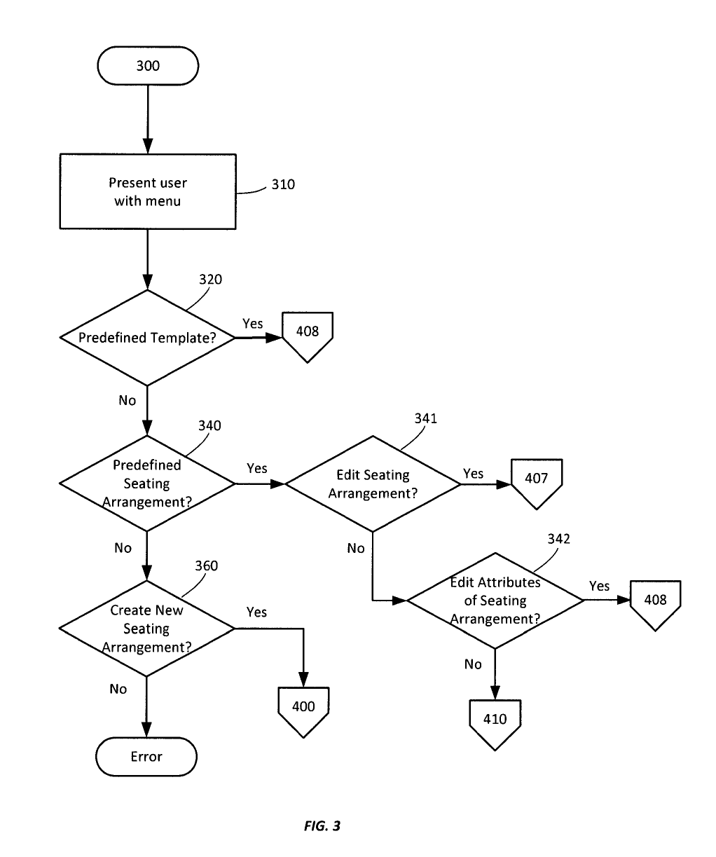

FIG. 3 illustrates one embodiment of an integrated process 300 for selecting and/or creating the seating arrangement and the ticket map for a venue using different modalities. In step 310, after choosing to configure a venue in step 202 of process 200, the user may be presented with a menu having several choices, such as step 320, where a pre-existing ticket template is selected, i.e., a complete seating plan having a seating arrangement and a corresponding ticket map previously configured; or step 340, wherein a predefined seating arrangement may be selected and a new ticket map created; or step 360, where a new seating arrangement and a new ticket map are created.

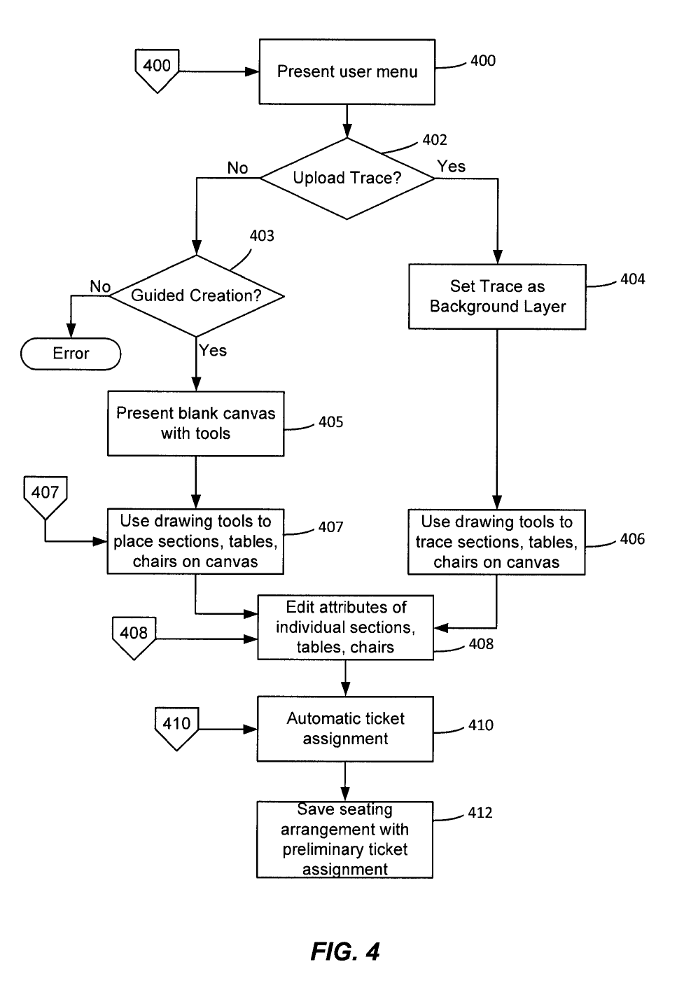

If the user selects a pre-existing ticket template in step 320, then the process jumps to step 408 (see FIG. 4) to permit editing of the seating arrangement attributes or subsequent ticket mapping steps. If the user selects a predefined seating arrangement in step 340, then the user may be presented with another choice: edit the predefined seating arrangement, or edit the attributes of the seating arrangement. If the user chooses to edit the seating arrangement in step 341, then the process jumps to step 407 to permit editing of the predefined seating arrangement. If the user chooses to edit the attributes of the seating arrangement in step 342, then the process jumps to step 408 to permit editing of only the attributes. If the user does not edit the seating arrangement or its attributes, then the process jumps to step 410 to begin the process of assigning tickets to seats.

If the user chooses to create a new seating arrangement in step 360, then the process jumps to step 400. Referring now to FIG. 4, in step 400, the user is presented with two choices: (i) upload an image of a seating arrangement for use with tracing tools, or (ii) use guided creation, e.g., a software wizard to guide the user in creating sections, tables and chairs on a blank canvas. If the user chooses to upload an image for tracing in step 402, then the image will be set as the background image for a tracing canvas in step 404. The tracing canvas includes a set of tools that may be used to trace sections, tables and chairs from the background image onto the canvas in step 406.

Attributes of individual sections, tables and chairs may be assigned and/or edited in step 408. For example, the sections, tables and/or chairs may be ranked or scored to best serve a desired selling order, preferred seating arrangement, pricing schedule, etc.

In one embodiment, automatic ticket assignment may be performed in step 410 according to any number of ticket criteria. For example, tickets may be assigned as a group to one or more sections, or to tables, or as individual tickets to individual chairs of tables or sections. Ticket criteria and methods are further described below. Finally, the seating arrangement and preliminary ticket map are saved in step 412.

If the user does not want to upload an image for tracing, but instead chooses guided creation in step 403, then the user is presented with a blank canvas and drawing tools in step 405. The drawing tools are used in step 407 to select and place a small library of objects, such as a table with chairs, or a section having x rows by y columns, onto the canvas. A wizard may be programmed to prompt the user to identify a total number of seats for the event, and how to organize the seats into tables or sections, as further described below. Once the floor plan is completed, attributes may be edited in step 408, already described.

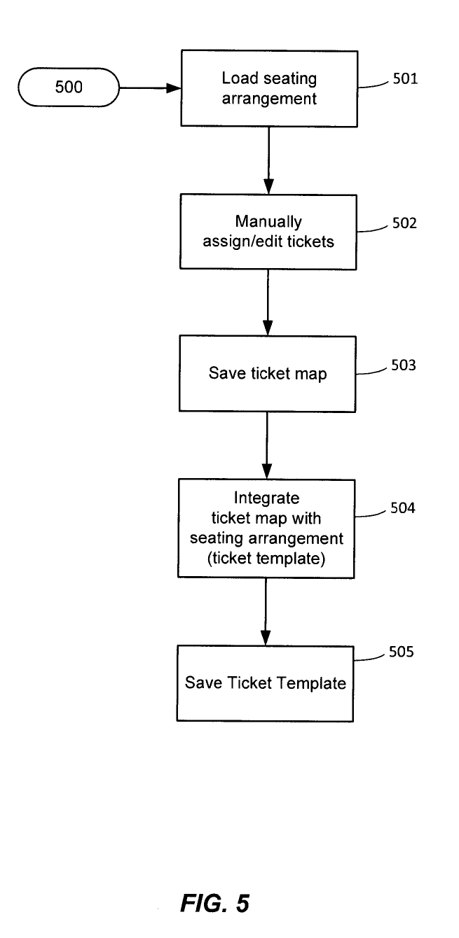

FIG. 5 illustrates one embodiment of a process 500 for finalizing a ticket template. In step 501, the seating arrangement created or selected for the event is retrieved and loaded into a current buffer. In step 502, ticket that was automatically assigned to the seating arrangement in step 410 can be edited or reassigned thereby creating the final ticket map for the event at this venue. In step 503, the ticket map is saved to a data store. In step 504, the ticket map is integrated with the seating arrangement to generate the ticket template for the event at this venue, which is saved in a data store in step 505.

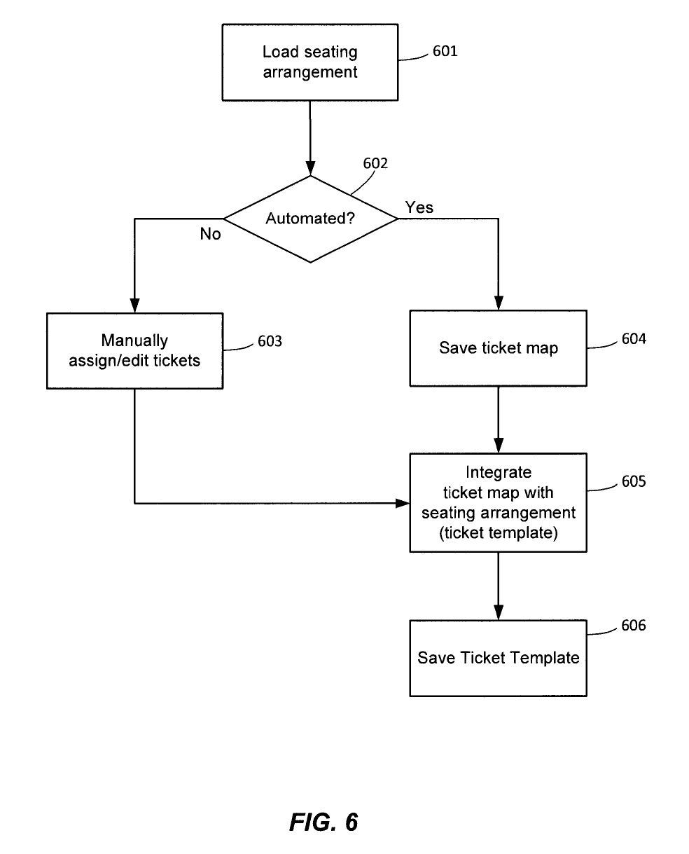

FIG. 6 illustrates another embodiment of a process 600 for assigning tickets or editing ticket assignments. In step 601, the seating arrangement is retrieved and loaded into a current buffer. If the process for assigning tickets is automated in step 602, then the ticket map is saved in step 604 then integrated with the seating arrangement in step 605 to form a ticket template. If the process for assigning tickets is not automated in step 602, then the user can manually assign and/or edit the tickets in step 603 before integrating the ticket map with the seating arrangement in step 605 to form the ticket template. Finally, the ticket template is saved in step 606.

The following describes examples of screen shots illustrating a user interface (UI) for a seat designer application that are provided to a user. As is common, the user may be presented with an initial welcome screen (not shown) to provide one or more introductory help screens to assist the user in becoming familiar with the application.

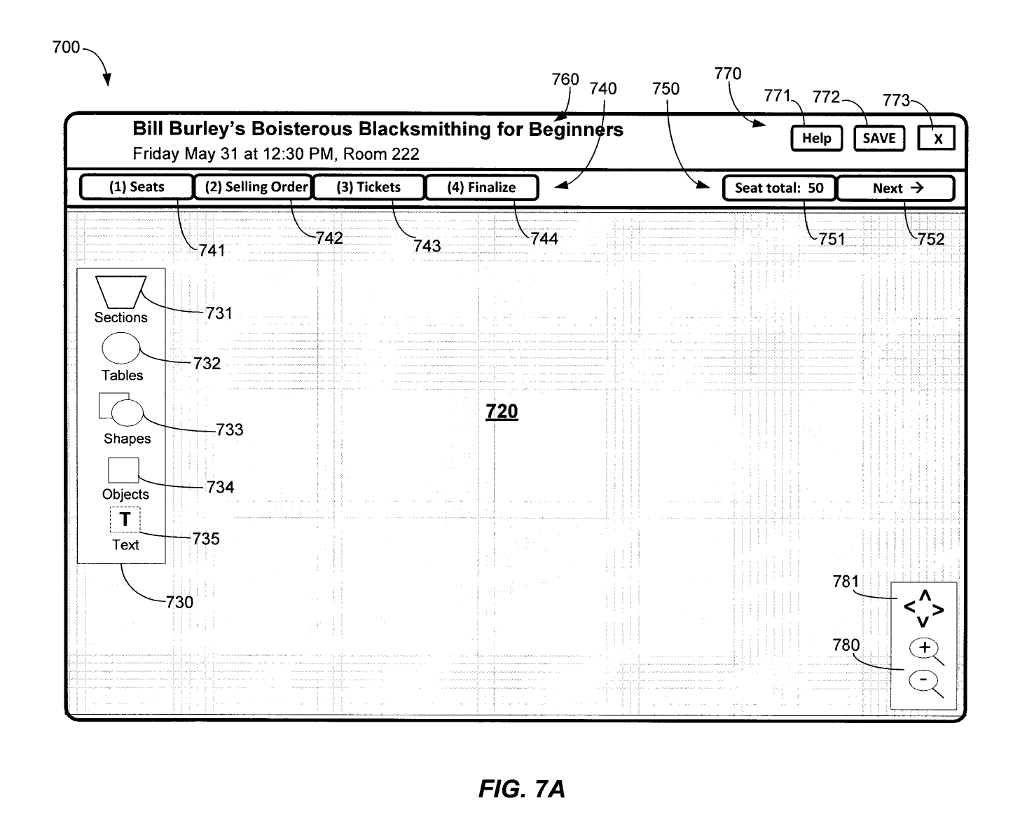

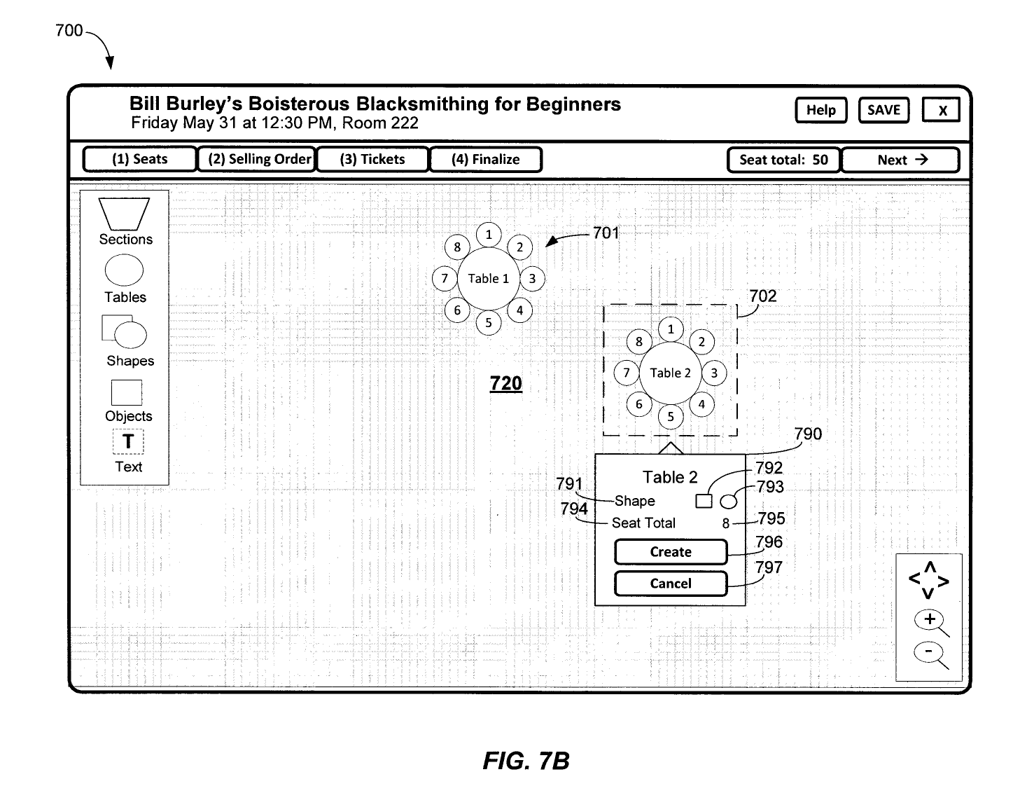

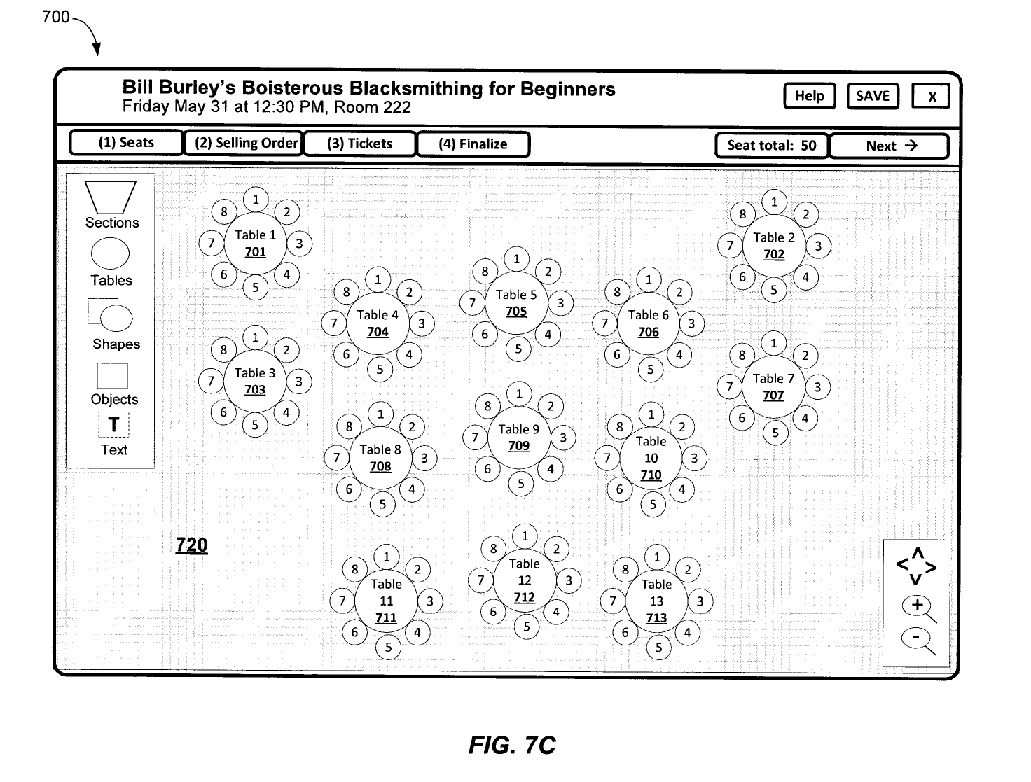

FIG. 7A illustrates the basic display 700 for a UI having a number of different functional elements. The main canvas 720 may be presented as a lined grid taking up most of the space of the window, and this is where the seating arrangement will be designed. A toolbar 730 includes a set of drawing tools, such as Sections tool 731, Table tool 732, Shapes tool 733, Objects tool 734 and Text tool 735. Selecting one of these tools from the toolbar 730 allows placement of a corresponding predefined object. For example, selecting the Sections tool 731 allows placement of a section having x rows and y tables per row; selecting the Table tool 732 allows placement of a table having z chairs and a selectable shape (round or rectangle); selecting the Shapes tool 733 allows placement of a round or rectangle shape for non-seat areas, such as a stage, serving tables, etc.; selecting the Objects tool 734 allows placement of an object, such as an obstruction, audio mixing board, etc.; and selecting the Text tool 745 allows the placement of text onto the canvas 720.

A tabbed navigation bar 740 is configured in a first ribbon area 721 above the canvas 720. The navigation bar 740 is the main means for the user to navigate to the different views within the seat designer application. The navigation bar 740 includes a first tab 741 labeled Seats, a second tab 742 labeled Selling Order, a third tab 743 labeled Tickets, and a fourth tab 744 labeled Final Review.

A status bar 750 is also configured in the first ribbon area 721. The status bar 750 may be configured with one or more widgets that are programmed to provide a dynamic update for one or more features of the event management application. For example, in the illustrated embodiment, the status bar 750 is configured with two widgets: a counter 751 labeled Seat total, and a button 752 labeled Next. The seat counter 751 is automatically updated while in the design mode to indicate how many seats have been configured in the seat design. Other widgets could also be configured to update other key statistics, for example, how many tickets have been sold thus far. Criteria for success are programmed into each step, and when the criteria have been met for a particular section, the Next button 752 will be active, for example, by highlighting the button, and selecting the Next button will take the user to the next step in the design process.

An event header 760 is configured above the first ribbon are 721 and includes the title and date of the event, and may include other relevant informational details about the event.

A control bar 770 is also configured above the first ribbon are 721, and includes a first button 771 labeled Help, a second button 772 labeled Save, and a third button 773 labeled X (for close). The Help button 771 is a link to launch the modal global help section of the website. The save button 772 allows the user to manually save any progress on their ticket template. A feature to automatically save progress can also be programmed. The close button 773 allows the user to exit the seat designer program at any time.

Zoom controls 780 and pan controls 781 may also be provided.

The design of a new seating plan starts by selecting the Seats tab 741 on the navigation bar 740, where a user can construct the physical aspects of a seat layout. Typically, the initial view will be a blank canvas, but other start-up options could be designed or enabled. For example, a series of modal screens can be presented allowing the user to select one of several different design modes.

In one embodiment, three discrete design modes are enabled: trace mode, canvas mode and focus mode. The user may be presented with a pop-up menu or equivalent to list the design mode choices.

A. The Canvas Mode

The canvas mode provides a simple set of tools so that the user can quickly create and position elements on a seating arrangement with a focus on making the seating arrangement spatially accurate and indicative of the actual venue layout. With the Sections tool 731 and the Tables tool 732 as described above, a user can create ticketable objects. Likewise, with the Shapes tool 733 and the Objects tool 734 as described above, the user can create non-ticketable objects. In the canvas mode, objects can be moved, rotated, copied/pasted, duplicated and deleted.

For example, in FIG. 7B, a first table object 701 has already been added to the canvas 720, and a second table object 702 is in the process of being added to the canvas. To add tables, the user selects the Tables tool 732 from the toolbar 730, then clicks on a location on the canvas to drop the table object. Thus, when table object 702 is dropped onto the canvas 720, a properties sheet 790 is presented, for example, as a pop-up window next to the object, so that the user can define the object via the properties sheet.

In this example, the properties sheet 790 for table object 702 includes a first widget 791 labeled “shape” that includes a first shape icon 792 for a rectangle and a second shape icon 793 for a circle. Selecting the rectangle icon 792 places a square table object on the canvas while selecting the circle icon 793 places a round table object on the canvas. A second widget 794 labeled “seat total” includes a data entry box 795 into which the user can enter the number of chairs to be configured for the table object. A default number can be programmed to be presented at the data box, with the ability for the user to change the number.

Finally, the properties sheet 790 includes a first button 796 labeled “create” and a second button 797 labeled “cancel.” Selecting the first button 796 creates the table object 702 while selecting the second button 797 would cancel creation of the object. Further, when the table object 702 is created, the counter 751 is automatically updated to reflect the total number of seats now configured for this seating arrangement.

In one embodiment, the canvas is automatically resized as objects are added. The working area of the canvas is set to be large enough to contain all the created objects. Likewise, the user should be able to create and add new objects and position them on the canvas without having to manage the canvas size. Thus, the canvas can be configured to expand as the user drags an object towards the boundary of the canvas. For example, in FIG. 7C, thirteen table objects 701-713 have been placed onto canvas 720, and the size of the canvas has been enlarged so that all thirteen objects are visible in UI 700.

B. The Trace Mode

The trace mode allows the user to upload a facsimile image of a floor plan, which is then set as a background image to the canvas. The user is provided with a simple set of drawing tools which may be used to trace the outlines of some or all of the sections of the uploaded floor plan image. The user can also use the uploaded image as a guide to aid in placing tables and chairs and/or sections and rows as the seat configuration.

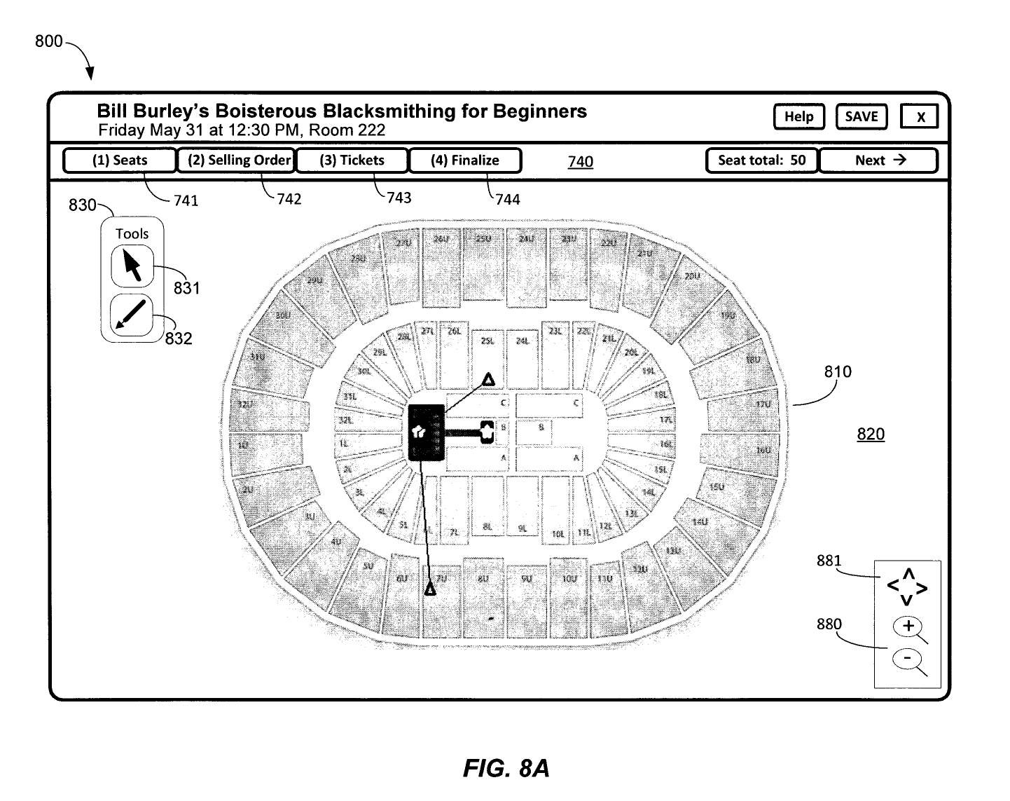

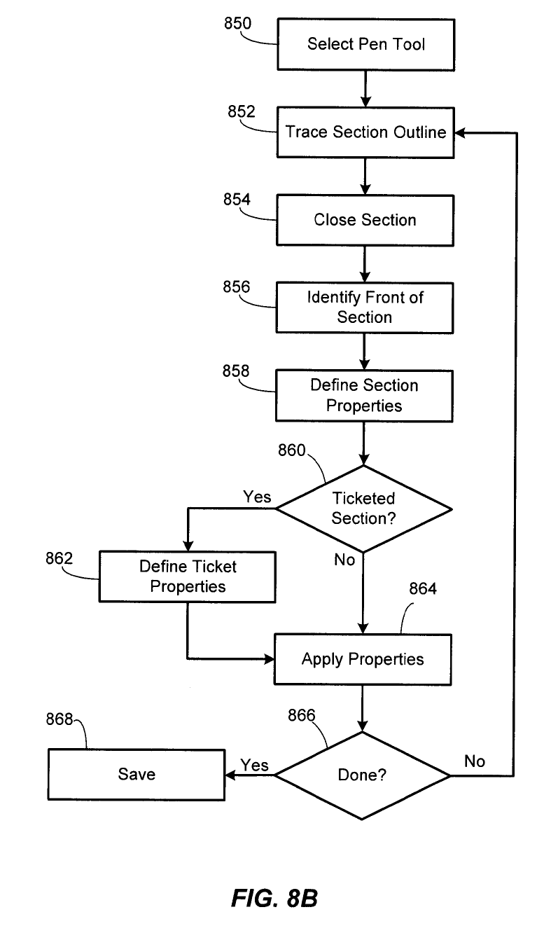

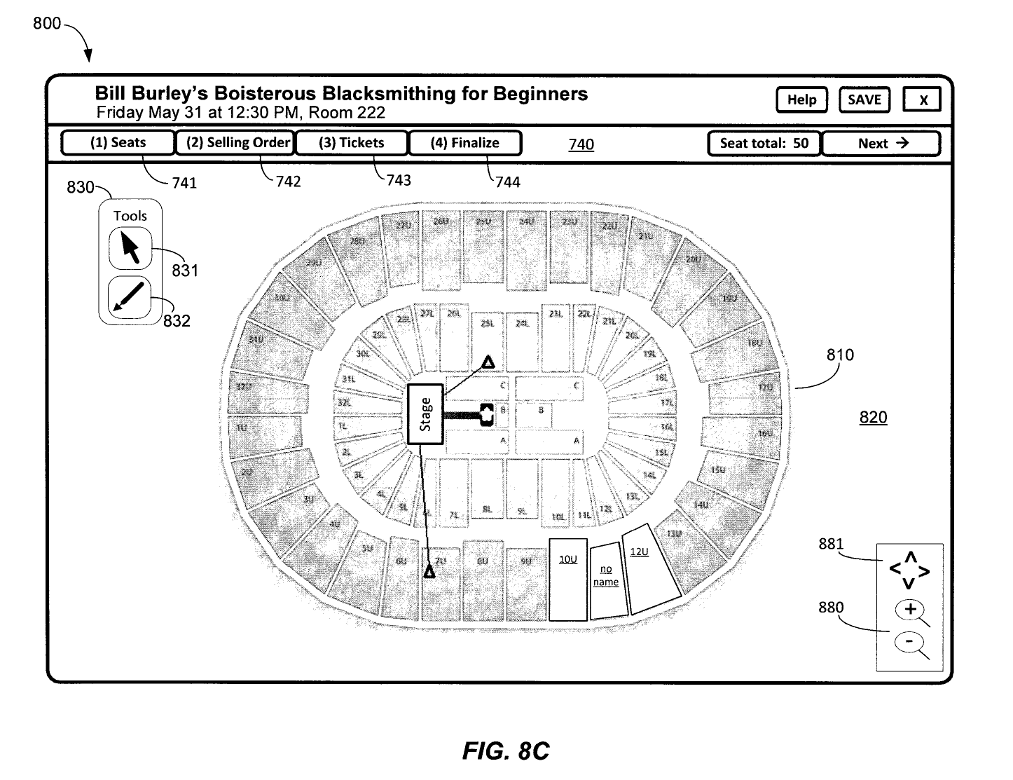

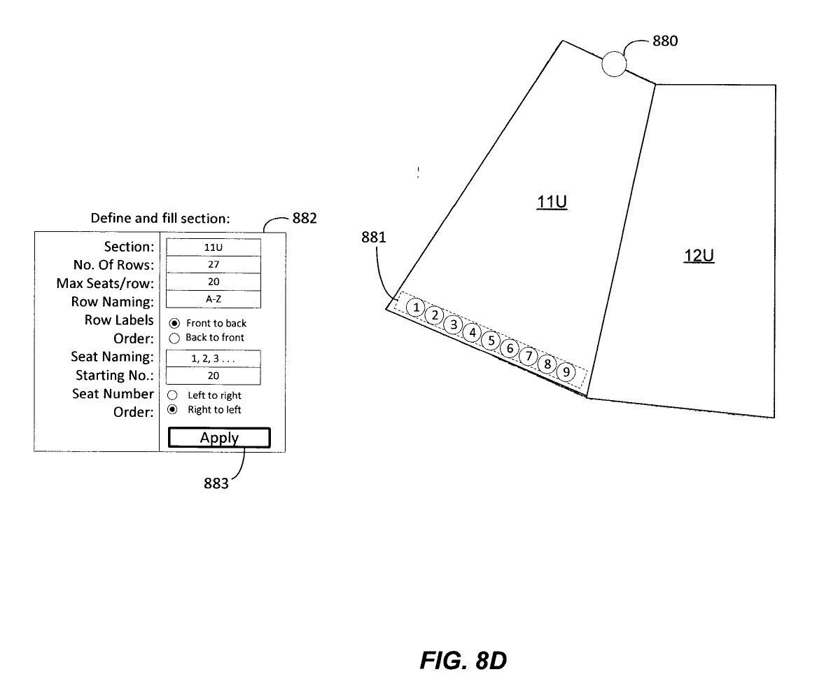

For example, FIG. 8A shows a UI 800 displayed in a section view of the trace mode, with an image 810 uploaded as a background image, or trace layer, under the canvas 820. The UI 800 includes a toolbar 830 with a pointer tool 831 and a pencil tool 832. The pencil tool 832 is used to trace or modify an outline of any of the sections shown in image 810.

The navigation bar 740 is the same as in the canvas mode, with seats tab 741, selling order tab 742, ticket map tab 743, and final review tab 744. A zoom control 880 and a pan control 881 are also provided.

At a certain level of zoom, the view can be configured to change from the section view mode to a seat view mode. In the seat view mode, the user can define rows and seats within an individual section or table.

In one embodiment, an opacity control can be provided (not shown) in which the opacity of the uploaded background image 810 can be adjusted from 0% to 100%. Further, controls may be provided to make the trace layer visible, to upload a new image, or to make the canvas grid visible.

FIG. 8B illustrates the work flow for creating a section using the trace mode. In step 850, the user selects the pencil tool 832 from the toolbar. In step 852, the user uses the pencil tool 832 to trace the outline of a section on the background image as a series of linked lines. In step 854, the user connects the last line to the first line and closes the shape that defines the section. In step 856, the user is prompted to set which direction the rows face. In step 858, the properties of the section are defined. In one embodiment, the user is asked to name the section and identify its type, namely, a ticketed section or a non-ticketed section. In step 860, if the user identifies the section as a ticketed section, then additional ticket properties are defined in step 862. Properties are then applied in step 864. If the tracing of sections is done in step 866, then the seating plan is saved in step 868 with a complete list of its seat and ticket attributes. Otherwise, the process returns to step 852 to trace another section outline.

FIG. 8C shows the same UI 800 as FIG. 8A, but with four sections traced onto the canvas from the background image, including a seat section 10U, a seat section labeled “no name” that will become section 11U, a seat section 12U, and a section labeled “stage.” Sections 10U and 12U have already had properties applied, but the section labeled “no name” is currently being created/edited, as will now be described.

The user may click onto a section to edit it even after properties have been applied. Referring to FIG. 8D, a polygon 11U has been traced from the background image, and the direction the rows face is indicated by placement of icon 880. The widest row 881 is then oriented so that it is properly positioned and faces front. For example, the row may be bent or otherwise manipulated if desired.

A data box 882 is then presented to the user to fully define and fill the section. For example, the user may enter the number of rows, the maximum number of seats per row, how to name the rows, the order of the rows, how to name the seats, etc. When the user hits the apply button 883, the section is filled as accurately and predictively as possible. Any seat falling outside the boundary of the section is deleted.

The user is then presented with a pop-up window asking the user to inspect the rows and seats to ensure they are correctly named and labeled. The user can zoom down to define or modify rows and seats within the section by clicking on a row or seat, or by using a zoom control. Once the edits are complete, the user clicks on a button to finalize the section.

C. The Focus Mode

The focus mode allows the user to focus on a single ticketable object rather than the entirety of the seating arrangement. The focus mode is entered when the user selects a ticketable object, i.e., a table and chairs, or a section. When the focus mode is entered, the selected object is enlarged (zoomed) so that it fits entirely within the window and it is centered both vertically and horizontally.

While in the focus mode, all options presented to the user will only affect the single object that is presented on the canvas. The user can add or remove individual seats or rows, or can change the labels and various other attributes of the ticketable object.

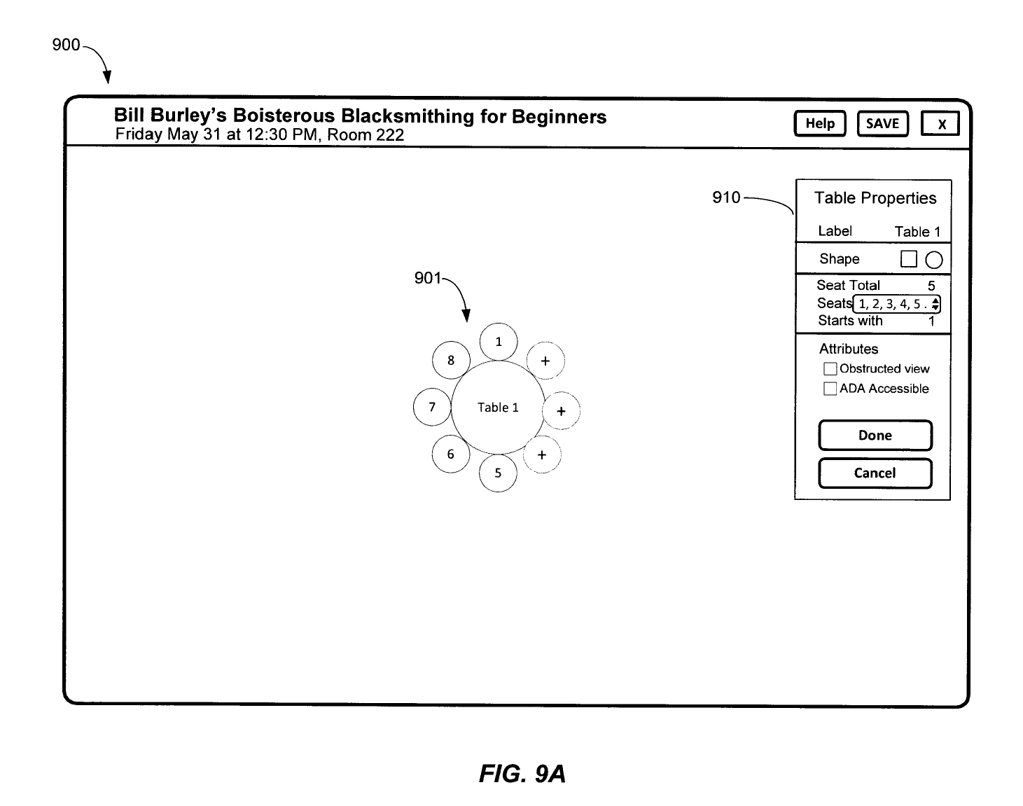

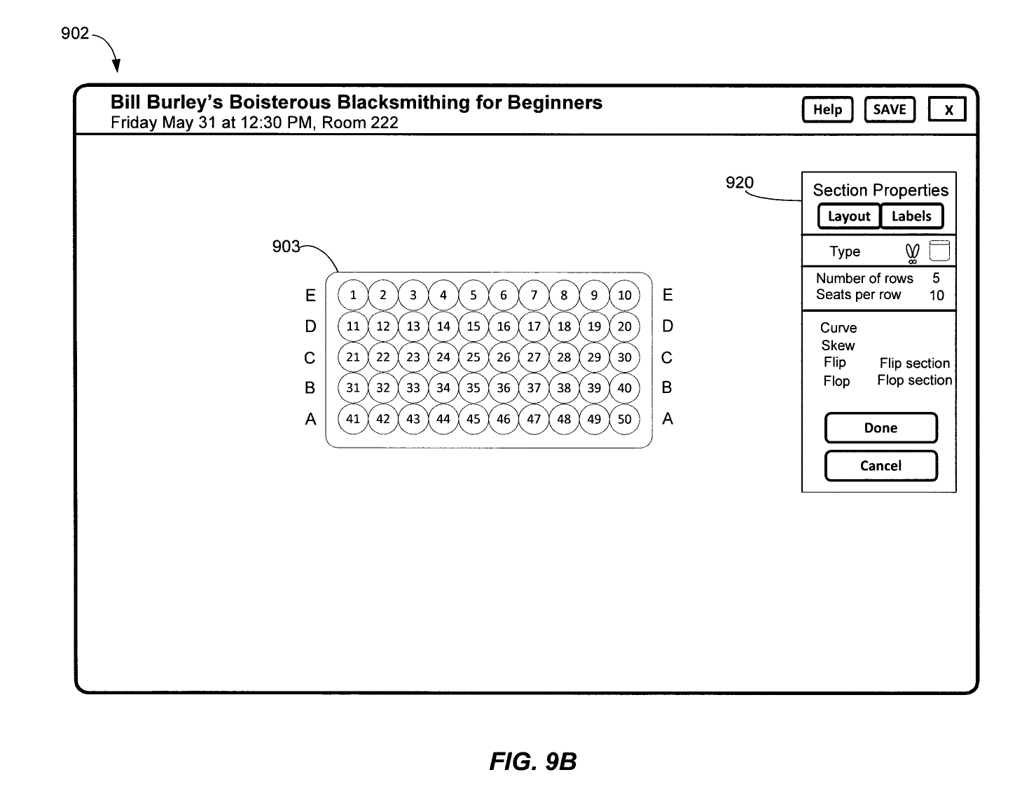

Referring to FIG. 9A, the focus mode for a table is illustrated by UI 900, which shows only table object 901 and a properties sheet 910 for the table object. The properties sheet 910 allows the user to change the label, the shape, the number of seats, the seat numbering, and other attributes, which are accepted when the done button is selected.

Referring to FIG. 9B, the focus mode for a section is illustrated by UI 902, which shows only section object 903 and a properties sheet 920 for the section object. The properties sheet 920 allows the user to change the label, the shape, the number of rows, the number of seats per row, and other attributes, which are accepted when the done button is selected.

In one embodiment, the act of grabbing and dragging the edge handles of the ticketable object expands the object to add seats, and the value in the property sheet for the ticketable object is automatically updated at the same time.

Selecting Done commits these changes to the object and exits focus mode. Once the user exits the focus mode, any physical changes to the object are visually apparent in canvas mode. Cancel exits the focus mode and the object reverts back to its state prior to entering the focus mode. Also, in the focus mode, the navigation bar is removed to ensure that the focus mode is exited via the properties sheet.

4. Creating a Ticket Map

Various ways of assigning tickets to seats are described above. As previously noted, assigning tickets to seats may or may not involve pricing the tickets. However, where ticket pricing is part of the event, a ticket plan must be adopted so that the event management system can apply the ticket plan to the seats to create a ticket map.

The seats may be scored or ranked to determine what pricing structure applies. For example, a focal point (such as the stage) may be identified in the venue, and the seats are scored based on their distance from the focal point, as described in co-pending U.S. application Ser. No. 14/099,828 entitled Ranking Reserved Seat on Event Management Systems, and incorporated herein by reference. Other seat attributes may be considered in setting a pricing plan. Further, the scoring or other attributes may be used as part of a scheme to automatically assign tickets to seats, and prices to tickets.

Pricing could be also set by section or by table, or part of a section. Geometrical shapes, such as a circle, arc, etc., could be superimposed on the seat plan to indicate different ticket types or prices. Some or all of these features may be incorporated into a scheme to either manually or automatically assign tickets to seats, and prices to tickets.

5. Exemplary Hardware Architecture

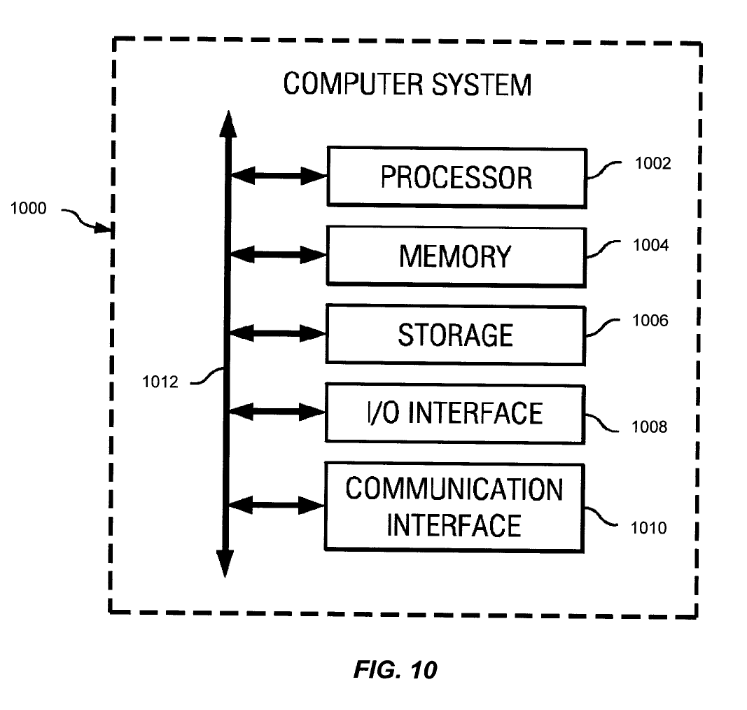

FIG. 10 illustrates one example of a computer system 1000 for performing one or more steps of one or more methods described or illustrated herein. Reference herein to a computer system may include any type of computing device, or may include one or more computer systems, where appropriate.

The computer system 1000 may take any suitable physical form. As one example, computer system 1000 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, or a combination of two or more of these. Where appropriate, computer system 1000 may include one or more computer systems; be unitary or distributed; span multiple locations; span multiple machines; span multiple data centers; or reside in a cloud, which may include one or more cloud components in one or more networks. Further, one or more computer systems 1000 may perform the steps or methods at different times or at different locations, where appropriate.

In one embodiment, the computer system 1000 includes a processor 1002, memory 1004, storage 1006, an input/output (I/O) interface 1008, a communication interface 10, and a bus 12. However, this disclosure contemplates any suitable computer system having any number of any relevant components in an effective arrangement.

Processor 1002 may include hardware for executing instructions, such as those making up a computer program. As an example and not by way of limitation, to execute instructions, processor 1002 may retrieve (or fetch) the instructions from an internal register, an internal cache, memory 1004, or storage 1006; decode and execute them; and then write one or more results to an internal register, an internal cache, memory 1004, or storage 1006. Processor 1002 may include one or more internal caches for data, instructions, or addresses. As an example and not by way of limitation, processor 1002 may include one or more instruction caches, one or more data caches, and one or more translation lookaside buffers (TLBs). Instructions in the instruction caches may be copies of instructions in memory 1004 or storage 1006, and the instruction caches may speed up retrieval of those instructions by processor 1002. Data in the data caches may be copies of data in memory 1004 or storage 1006 for instructions executing at processor 1002 to operate on; the results of previous instructions executed at processor 1002 for access by subsequent instructions executing at processor 1002 or for writing to memory 1004 or storage 1006; or other suitable data. The data caches may speed up read or write operations by processor 1002. The TLBs may speed up virtual-address translation for processor 1002.

The processor 1002 may include one or more internal registers for data, instructions, or addresses. Where appropriate, processor 1002 may include one or more arithmetic logic units (ALUs); be a multi-core processor; or include one or more processors.

Memory 1004 includes main memory for storing instructions for processor 1002 to execute or data for the processor to operate on. As an example and not by way of limitation, computer system 1000 may load instructions from storage 1006 or another source (such as, for example, another computer system) to memory 1004. Processor 1002 may then load the instructions from memory 1004 to an internal register or internal cache. To execute the instructions, processor 1002 may retrieve the instructions from the internal register or internal cache and decode them. During or after execution of the instructions, processor 1002 may write one or more results (which may be intermediate or final results) to the internal register or internal cache. Processor 1002 may then write one or more of those results to memory 1004.

Processor 1002 executes only instructions or data in one or more internal registers or internal caches or in memory 1004 (as opposed to storage 1006 or elsewhere). One or more memory buses (which may each include an address bus and a data bus) may couple processor 1002 to memory 1004. Bus 12 may include one or more memory buses, as described below.

One or more memory management units (MMUs) may reside between processor 1002 and memory 1004 and facilitate access to memory 1004 requested by the processor. Memory 1004 may include random access memory (RAM), which may be volatile memory, dynamic RAM (DRAM) or static RAM (SRAM). Moreover, where appropriate, this RAM may be single-ported or multi-ported RAM.

Storage 1006 may include mass storage for data or instructions. As an example and not by way of limitation, storage 1006 may include a hard disk drive (HDD), a floppy disk drive, flash memory, an optical disc, a magneto-optical disc, magnetic tape, or a Universal Serial Bus (USB) drive or a combination of two or more of these. Storage 1006 may include removable or non-removable (or fixed) media, where appropriate. Storage 1006 may be internal or external to computer system 1000, where appropriate. Storage 1006 may be non-volatile, solid-state memory, read-only memory (ROM), mask-programmed ROM, programmable ROM (PROM), erasable PROM (EPROM), electrically erasable PROM (EEPROM), electrically alterable ROM (EAROM), or flash memory or a combination of two or more of these. Storage 1006 may include one or more storage control units facilitating communication between processor 1002 and the storage, where appropriate.

I/O interface 1008 includes hardware, software, or both, providing one or more interfaces for communication between computer system 1000 and one or more I/O devices. Computer system 1000 may include one or more of these I/O devices, where appropriate, to enable communication between a user and the computer system. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. I/O interface 1008 may include one or more device or software drivers enabling processor 1002 to drive one or more of these I/O devices.

Communication interface 10 may include hardware, software, or both providing one or more interfaces for communication (such as, for example, packet-based communication) between computer system 1000 and one or more other computer systems or one or more networks. As an example and not by way of limitation, communication interface 10 may include a network interface controller (NIC) or network adapter for communicating with an Ethernet or other wire-based network or a wireless NIC (WNIC) or wireless adapter for communicating with a wireless network, such as a WI-FI network. As an example and not by way of limitation, computer system 1000 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 1000 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these.

Bus 12 may include hardware, software, or both coupling components of computer system 1000 to each other. As an example and not by way of limitation, bus 12 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these.

A non-transitory computer-readable storage medium may include one or more semiconductor-based or other integrated circuits (ICs) (such, as for example, field-programmable gate arrays (FPGAs) or application-specific Ics (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable non-transitory computer-readable storage media, or any suitable combination of two or more of these, where appropriate. A computer-readable non-transitory storage medium may be volatile, non-volatile, or a combination of volatile and non-volatile, where appropriate.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative.

1. A method comprising:
configuring, by a server running an event management application, in response to user input, a first seating arrangement for a first event at a first venue;
configuring, by the server, in response to user input, a first ticket map for the first seating arrangement by assigning a ticket to each of a plurality of seats in the first seating arrangement;
generating by the server, and storing in a memory accessible to the server, a first ticket template that integrates the first ticket map with the first seating arrangement for the first venue; and
publishing, by the server, the first ticket template as a seating plan for the first event.

2. The method of claim 1, further comprising:
retrieving the first ticket template from the memory; and
publishing, by the server, the first ticket template as a seating plan for a second event.

3. The method of claim 1, further comprising:
retrieving the first ticket template from the memory;
modifying, by the server, in response to user input, the first seating arrangement of the first ticket template to form a second seating arrangement;
configuring, by the server, in response to user input, a second ticket map for the second seating arrangement by assigning a ticket to each of a plurality of seats in the second seating arrangement;
generating by the server, and storing in the memory, a second ticket template that integrates the second ticket map with the second seating arrangement for the first venue; and
publishing, by the server, the second ticket template as a seating plan for the second event.

4. The method of claim 1, further comprising:
retrieving the first ticket template from the memory;
modifying, by the server, in response to user input, the first ticket map of the first ticket template to form a third ticket map by modifying the assignment of tickets to each seat in the first seating arrangement,
generating by the server, and storing in the memory, a third ticket template that integrates the third ticket map with the first seating arrangement for the first venue; and
publishing, by the server, the third ticket template as a seating plan for the second event.

5. The method of claim 1, wherein the step of configuring a first seating arrangement further comprises organizing the seats into tables, or rows, or sections and rows.

6. The method of claim 5, wherein the step of configuring a first seating arrangement further comprises generating a series of predefined user interfaces for guiding a user to organize the seats into tables, or rows, or sections and rows.

7. The method of claim 1, wherein the step of configuring a first seating arrangement comprises:
receiving an image of a prior seating arrangement for the first venue;
setting the image of the prior seating arrangement as a background image underneath an electronic canvas on a user display;
tracing onto the electronic canvas with a drawing tool one or more portions of the prior seating arrangement; and
configuring the one or more portions of the prior seating arrangement to generate the first seating arrangement.

8. The method of claim 1, wherein the step of configuring a first seating arrangement comprises:
generating, by the server, a user interface for a user display, the user interface having an electronic canvas and a plurality of drawing tools configured for placing and manipulating seating objects on the electronic canvas; and
receiving, by the server via the user interface, user input to place and manipulate a plurality of seating objects on the electronic canvas with at least one drawing tool to create the first seating arrangement.

9. The method of claim 8, wherein the first seating arrangement includes a plurality of seating objects, the step of configuring a first seating arrangement further comprises receiving user input to modify a seating object in the first seating arrangement.

10. The method of claim 1, further comprising:
identifying, based on user input, a focal point for the first seating arrangement;
assigning a seat score to each seat in the first seating arrangement on the basis of the proximity of the seat to the focal point; and
assigning a value to each ticket on the basis of the seat score.

11. The method of claim 10, the step of configuring a first ticket map further comprising automatically assigning a ticket to each seat on the basis of the seat score.

12. A method comprising:
generating, by a server running an event management application, a user interface for a user display, the user interface having an electronic canvas and a plurality of tools configured for working with the electronic canvas including drawing tools configured for placing and manipulating seating objects on the electronic canvas;
receiving, by the server via the user interface, user input to place and manipulate a plurality of seating objects on the electronic canvas with at least one drawing tool to create a first seating arrangement for a first venue, the first seating arrangement including the plurality of seating objects;
receiving, by the server, user input to assign a ticket to each of the plurality of seating objects in the first seating arrangement;
generating, by the server, a first ticket map for the first seating arrangement based on the user input assigning a ticket to each of the plurality of seating objects;
generating, by the server, and storing in memory accessible to the server, a first ticket template that integrates the first seating arrangement with the first ticket map; and
publishing, by the server, the first ticket template as a seating plan for the first event.

13. The method of claim 12, further comprising:
generating, by the server, a first series of predefined user interfaces in response to user input for guiding the user to place and manipulate the seating objects on the electronic canvas.

14. The method of claim 13, the first series of predefined user interfaces including interfaces for guiding the user to organize the seating objects into tables, or rows, or sections and rows.

15. The method of claim 12, further comprising:
generating, by the server, a second series of predefined user interfaces in response to user input for guiding the user to assign a ticket to each of the seating objects in the first seating arrangement.

16. The method of claim 12, further comprising:
retrieving the first ticket template from the memory;
modifying, by the server, in response to user input, the first seating arrangement of the first ticket template to form a second seating arrangement;
configuring, by the server, in response to user input, a second ticket map for the second seating arrangement by assigning a ticket to each of the seating objects in the second seating arrangement;
generating, by the server, and storing in the memory a second ticket template that integrates the second ticket map with the second seating arrangement for the first venue; and
publishing, by the server, the second ticket template as a seating plan for the second event.

17. The method of claim 12, further comprising:
retrieving the first ticket template from the memory;
modifying, by the server, in response to user input, the first ticket map of the first ticket template to form a third ticket map by modifying the assignment of tickets to each seating object in the first seating arrangement,
generating, by the server, and storing in the memory, a third ticket template that integrates the third ticket map with the first seating arrangement for the first venue; and
publishing, by the server, the third ticket template as a seating plan for the second event.

18. The method of claim 12, further comprising:
receiving an image of a prior seating arrangement for the first venue;
setting the image of the prior seating arrangement as a background image underneath the electronic canvas on a user display;
tracing onto the electronic canvas with one of the drawing tools one or more portions of the prior seating arrangement; and
configuring the one or more portions of the prior seating arrangement to generate the first seating arrangement.

19. A computer program product, comprising a non-transitory computer-readable medium containing one or more sequences of instructions executable by a processor in a computer, wherein the instructions, when executed by the processor, cause the processor to:
generate a first series of predefined user interfaces for display to a user for configuring a first seating arrangement for a first venue;
receive input from the user in response to the display of the first series of user interfaces;
generate the first seating arrangement for the first venue based on the user input to the first series of user interfaces, the first seating arrangement having a plurality of seating objects;
generate a second series of predefined user interfaces for display to the user for assigning a ticket to each of a plurality of seating objects in the first seating arrangement;
receive input from the user in response to the display of the second series of user interfaces;
generate a first ticket map for the first seating arrangement based on the user input to the second series of user interfaces, the first ticket map having a ticket assigned to each seating object;
generate and store a first ticket template that integrates the first ticket map with the first seating arrangement for the first venue; and
publish the first ticket template as a seating plan for the first event.

20. The method of claim 19, further comprising:
receiving an image of a prior seating arrangement for the first venue;
setting the image of the prior seating arrangement as a background image underneath an electronic canvas on a user display;
tracing onto the electronic canvas with a drawing tool one or more portions of the prior seating arrangement; and
configuring the one or more portions of the prior seating arrangement to generate the first seating arrangement.
